(19) United States
(12) Patent Application Publication
(10) Pub. No.: US 2022/0350029 A1
(43) Pub. Date: Nov. 3, 2022

(54) RADIO FREQUENCY ARCHITECTURE AND MOBILE TERMINAL

(71) Applicant: HuiZhou TCL Mobile Communication Co., Ltd., HuiZhou, Guangdong (CN)

(72) Inventors: Yu JIA, Huizhou, Guangdong (CN); Dingning WEN, Huizhou, Guangdong (CN); Hua ZHANG, Huizhou, Guangdong (CN); Longxi TAO, Huizhou, Guangdong (CN)

(73) Assignee: HuiZhou TCL Mobile Communication Co., Ltd., HuiZhou, Guangdong (CN)

(21) Appl. No.: 17/621,756

(22) PCT Filed: Dec. 17, 2019
(86) PCT No.: PCT/CN2019/125939

§ 371 Date: Dec. 22, 2021

(30) Foreign Application Priority Data
Dec. 5, 2019 (CN) 201911235791.5

(51) Int. Cl. G01S 19/21

(52) U.S. Cl. CPC G01S 19/21

(57) ABSTRACT

A radio-frequency architecture is provided. By setting an independent radio-frequency channel including a B13 duplexer, LTE_B13 main wave signals, being output by a power amplifier and passing through the B13 duplex, are emitted directly from a second main antenna without passing through any non-linear device.

This application claims the benefits of International Application No. PCT/CN2019/125939, filed Dec. 17, 2019, which claims priority to Chinese Application No. 201911235791.5, filled on Dec. 5, 2019. The entire disclosures of each of the applications are incorporated herein by reference.

### TECHNICAL FIELD

The present application relates to a terminal field, and more particularly, to a radio-frequency architecture and a mobile terminal.

### BACKGROUND

When global positioning system (GPS) functions of present mobile phones supporting LTE_B13 frequency band [band 13 frequency band of long-term evolution (LTE)] need to be implemented, antennas need to be set separately on radio-frequency channels and GPS channels. Moreover, LTE_B13 main wave signals, passing through power amplifiers, duplexers, radio-frequency modules and switches, are transmitted out from main antennas and diversity antennas. Information received by GPS antennas need to be filtered by GPS filters.

Wherein, an emitting frequency of the LTE_B13 ranges from 777 MHz to 787 MHz, a center frequency of receiving GPS signals is 1572.82 MHz. Currently, the GPS antennas and the diversity antennas are both set on the mobile phone, and distances between them are relatively short. When the signals with the LTE_B13 frequency band are transmitted and the GPS functions are operated at the same time, sources of interference to the GPS functions comes from two points: one is that once the signals with the LTE_B13 frequency band pass through the radio-frequency modules, switches, and other non-linear devices on the radio-frequency channel, second harmonic waves will be generated and transmitted out from the diversity antennas. Since there is low isolation of current commercial duplexers for a GPS frequency band, the second harmonic waves cannot be completely filtered out, and these signals enter the GPS channels through coupling of the GPS antennas and directly cause the interference to the GPS functions; another point is that isolation of the switches (double pole double throw switch, used to switch between upper and lower antennas) is about 25 dB. That is, when a B13 duplexer transmits signals at maximum power, signals with 0 dBm power will pass through the switches and enter the diversity antennas, accompanied with the second harmonic waves with the LTE_B13 frequency band. GPS is unable to locate or unable to locate correctly, caused by the second harmonic waves generated in terms of the above two situations.

### Technical Problem

The present application provides a radio-frequency architecture and a mobile terminal to reduce interference of a radio frequency channel with respect to a GPS (global positioning system) channel.

### Technical Solution

According to a first aspect of the present application, the present application provides a radio-frequency architecture, comprising: a global positioning system (GPS) channel comprising a GPS antenna and a GPS filter, wherein the GPS filter is a high-pass filter; a first radio-frequency channel comprising a power amplifier, a first duplexer, a radio-frequency module and a switch that are connected in sequence, and comprising a first main antenna and a diversity antenna that are all connected to the switch; and a second radio-frequency channel comprising the power amplifier, a second duplexer, a filter, and a second main antenna that are connected in sequence.

Further, the switch is a double pole double throw (DPDT) switch.

Further, the switch is a non-linear device.

Further, the radio-frequency module is a non-linear device.

Further, the filter is a low-pass filter.

Further, the second duplexer is a B13 duplexer.

Further, twice an emitting frequency of the second duplexer is a GPS frequency band.

According to a second aspect of the present application, the present application provides a radio-frequency architecture, comprising: a global positioning system (GPS) channel; a first radio-frequency channel comprising a power amplifier, a first duplexer, a radio-frequency module and a switch that are connected in sequence, and comprising a first main antenna and a diversity antenna that are all connected to the switch; and a second radio-frequency channel comprising the power amplifier, a second duplexer, a filter, and a second main antenna that are connected in sequence.

Further, the GPS channel comprises a GPS antenna and a GPS filter.

Further, the GPS filter is a high-pass filter.

Further, the switch is a double pole double throw (DPDT) switch.

Further, the switch is a non-linear device.

Further, the radio-frequency module is a non-linear device.

Further, the filter is a low-pass filter.

Further, the second duplexer is a B13 duplexer.

Further, twice an emitting frequency of the second duplexer is a GPS frequency band.

According to a third aspect of the present application, the present application provides a mobile terminal, comprising the radio-frequency architecture as described above.

### Beneficial Effect

Compared to the prior art, an embodiment of the present application provides a radio-frequency architecture and a mobile terminal, by setting an independent radio-frequency channel including a B13 duplexer, LTE_B13 main wave signals, being output by a power amplifier and passing through the B13 duplex, are transmitted out directly from a second main antenna without passing through any non-linear devices. Therefore, influence of the B13 main wave signals and B13 second harmonic wave signals on a global positioning system (GPS) channel only exists in coupling between antennas, which greatly reduces interference of the radio-frequency channel with respect to the GPS channel.

### DESCRIPTION OF DRAWINGS

FIG. 1 is a schematic structural diagram showing a radio-frequency architecture according to an embodiment of the present application.

FIG. 2 is a schematic structural diagram showing a mobile terminal according to an embodiment of the present application.

### DETAILED DESCRIPTION OF PREFERRED EMBODIMENTS

Technical solutions in an embodiment of the present application will be clearly and completely described below in conjunction with drawings in the embodiment of the present application. Obviously, the embodiment described are only a portion of embodiments of the present application, not all of them. Based on the embodiment of the present application, other embodiments obtained by persons skilled in this art under the premise of no creative efforts made are within a protection scope of the present application.

Terms such as “first”, “second”, and “third” (if existing) in the specification, the claims, and the described-above drawings of the present application are only used for distinguishing between similar objects, and are not used for describing a particular sequence or precedence. It should be understood that the objects described in this way can be interchanged under appropriate circumstances. In addition, terms such as “include”, “have”, and any variations of them are intended to cover non-exclusive inclusions.

In the specific embodiment, the drawings described below and various embodiments used to describe principles disclosed in the present application are only used for illustrating, and should not be construed as limiting the scope of disclosure of the present application. Persons skilled in this art may understand that the principles of the present application can be implemented in any suitably arranged system. Exemplary embodiments will be described in detail, and examples of these embodiments will be shown in the drawings. In addition, a terminal described in the exemplary embodiments will be described in detail with reference to the accompanying drawings. The same reference numbers in the drawings refer to the same elements.

Terms used in the present specific embodiment are only used to describe specific embodiments and are not intended to show concepts of the present application. Unless there is a clearly different meaning in the context, expressions used in singular form include expressions in plural form. In the specification of the present application, it should be understood that terms such as “including”, “having”, and “containing” are intended to indicate possibility of features, numbers, steps, actions, and combinations thereof disclosed in the specification of the present application, and are not intended to excludes possibility that one or more other features, numbers, steps, actions, and combinations thereof may be present or may be added. The same reference numbers in the drawings refer to the same parts.

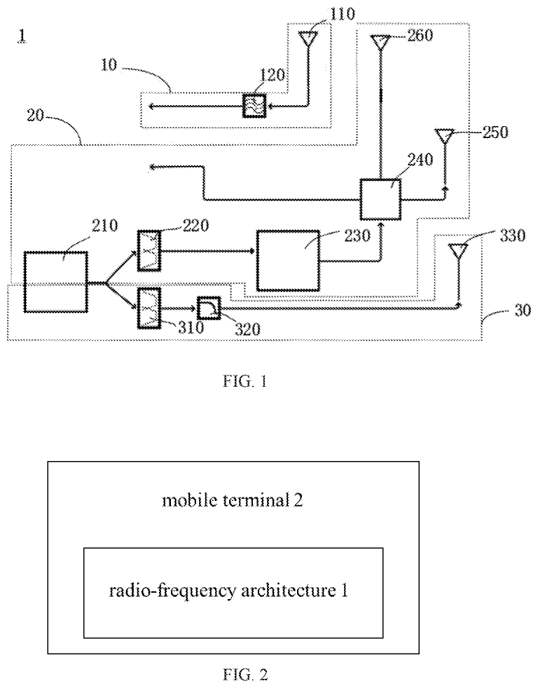

As shown in FIG. 1, the present application provides a radio-frequency architecture, including a global positioning system (GPS) channel 10, a GPS antenna 110, a GPS filter 120, a first radio-frequency channel 20, a power amplifier 210, a first duplexer 220, a radio-frequency module 230, a switch 240, a first main antenna 250, a diversity antenna 260, a second radio frequency channel 30, a second duplexer 310, a filter 320, and a second main antenna 330.

In the embodiment of the present application, the GPS channel 10 may include a GPS antenna 110 and a GPS filter 120.

Wherein, the GPS antenna 110 is used to receive GPS signals, and a center frequency of the GPS signals is 1572.82 MHz.

In the embodiment of the present application, the GPS filter 120 is a high-pass filter, which also has been known as a low-cutoff filter or a low-bandstop filter. The high-pass filter is a filter that allows frequencies higher than a certain cut-off frequency to pass, and greatly attenuates lower frequencies. Unnecessary low frequencies of signals or low-frequency interference can be removed by the high-pass filter.

In the embodiment of the present application, the first radio-frequency channel 20 includes a power amplifier 210, a first duplexer 220, a radio-frequency module 230, a switch 240 that are connected in sequence, and includes a first main antenna 250 and a diversity antenna 260 that are all connected to the switch 240.

The power amplifier 210 refers to an amplifier that can generate a maximum power output to drive a certain load under a given distortion rate.

The first duplexer 220 includes, but is not limited to, a B2 duplexer or a B25 duplexer, wherein a function of the duplexers is to isolate transmitting signals and receiving signals to ensure that a receiving operation and a transmitting operation can be operated normally at the same time.

The radio-frequency module 230 is used to transmit analog and digital signals. The radio-frequency module 230 is a non-linear device.

In the present application embodiment, the switch 240 is a double pole double throw (DPDT) switch, which is configured to switch between the first main antenna 250 and the diversity antenna 260. Specifically, the switch 240 is a non-linear device.

In the embodiment of the present application, the second radio-frequency channel 30 includes a power amplifier 210, a second duplexer 310, a filter 320, and a second main antenna 330 that are connected in sequence.

The second duplexer 310 may be a B13 duplexer. An emitting frequency of the second duplexer 310 ranges from 777 MHz to 787 MHz, and twice the emitting frequency of the second duplexer 310 is a GPS frequency band.

In the embodiment of the present application, the filter 320 is a low-pass filter, which also has been known as a high-cutoff filter or a high-bandstop filter. The low-pass filter is a filter that allows frequencies lower than a certain cut-off frequency to pass, and greatly attenuates higher frequencies. Unnecessary high frequencies of signals or high-frequency interference can be removed by the high-pass filter.

The second main antenna 330 is used to transmit B13 signals.

In the present embodiment, by setting an independent radio-frequency channel including the B13 duplexer, LTE_B13 main wave signals, being output by the power amplifier and passing through the B13 duplex, are transmitted out directly from the second main antenna without passing through any non-linear devices (such as the switches 240 and the radio-frequency module 230 shown in FIG. 1). Therefore, influence of the B13 main wave signals and B13 second harmonic wave signals on the GPS channel only exists in coupling between antennas, which greatly reduces interference of the radio-frequency channel with respect to the GPS channel.

As shown in FIG. 2, the present application provides a mobile terminal 2 including the radio-frequency architecture 1 described above. The mobile terminal 2 may be a product such as a mobile phone, a tablet computer, a notebook computer, or a navigator.

In the present application, by setting an independent radio-frequency channel including the B13 duplexer, LTE_B13 main wave signals, being output by the power amplifier and passing through the B13 duplex, are transmitted out directly from the second main antenna without passing through any non-linear devices. Therefore, influence of the B13 main wave signals and B13 second harmonic wave signals on the GPS channel only exists in coupling between antennas, which greatly reduces interference of the radio-frequency channel with respect to the GPS channel.

The radio-frequency architecture and the mobile terminal provided by the embodiment of the application are described in detail above. Specific examples are used in the context to illustrate the principles and implementation of the present application. The above description for the embodiment is only used to help understand approaches and core ideas of the present application. Furthermore, for persons skilled in this art, according to ideas of the present application, there will be changes in specific implementation and the scope. In summary, the content of the present specification should not be construed as a limitation to the present application.

1. A radio-frequency architecture, comprising:
a global positioning system (GPS) channel comprising a GPS antenna and a GPS filter, wherein the GPS filter is a high-pass filter;
a first radio-frequency channel comprising a power amplifier, a first duplexer, a radio-frequency module and a switch that are connected in sequence, and comprising a first main antenna and a diversity antenna that are all connected to the switch; and
a second radio-frequency channel comprising the power amplifier, a second duplexer, a filter, and a second main antenna that are connected in sequence.

2. The radio-frequency architecture as claimed in claim 1, wherein the switch is a double pole double throw (DPDT) switch.

3. The radio-frequency architecture as claimed in claim 2, wherein the switch is a non-linear device.

4. The radio-frequency architecture as claimed in claim 1, wherein the radio-frequency module is a non-linear device.

5. The radio-frequency architecture as claimed in claim 1, wherein the filter is a low-pass filter.

6. The radio-frequency architecture as claimed in claim 1, wherein the second duplexer is a B13 duplexer.

7. The radio-frequency architecture as claimed in claim 1, wherein twice an emitting frequency of the second duplexer is a GPS frequency band.

8. A radio-frequency architecture, comprising:
a global positioning system (GPS) channel;
a first radio-frequency channel comprising a power amplifier, a first duplexer, a radio-frequency module and a switch that are connected in sequence, and comprising a first main antenna and a diversity antenna that are all connected to the switch; and
a second radio-frequency channel comprising the power amplifier, a second duplexer, a filter, and a second main antenna that are connected in sequence.

9. The radio-frequency architecture as claimed in claim 8, wherein the GPS channel comprises a GPS antenna and a GPS filter.

10. (canceled)

11. The radio-frequency architecture as claimed in claim 8, wherein the switch is a double pole double throw (DPDT) switch.

12. The radio-frequency architecture as claimed in claim 11, wherein the switch is a non-linear device.

13. The radio-frequency architecture as claimed in claim 8, wherein the radio-frequency module is a non-linear device.

14. The radio-frequency architecture as claimed in claim 8, wherein the filter is a low-pass filter.

15. The radio-frequency architecture as claimed in claim 8, wherein the second duplexer is a B13 duplexer.

16. The radio-frequency architecture as claimed in claim 8, wherein twice an emitting frequency of the second duplexer is a GPS frequency band.

17. A mobile terminal, comprising the radio-frequency architecture as claimed in claim 8.

18. The radio-frequency architecture as claimed in claim 1, wherein the first duplexer is one of a B2 duplexer and a B25 duplexer.

19. The radio-frequency architecture as claimed in claim 9, wherein the first duplexer is one of a B2 duplexer and a B25 duplexer.
